(19) United States
(12) Patent Application Publication
(10) Pub. No.: US 2007/0165010 A1
(43) Pub. Date: Jul. 19, 2007

(54) Multi-direction roller structure for input device

(75) Inventor: Heng-Ju Lo, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/484,709

(22) Filed: Jul. 12, 2006

(30) Foreign Application Priority Data
Jul. 13, 2005 (TW) 94123795

(51) Int. Cl. G09G 5/00

(52) U.S. Cl. 345/184

(57) ABSTRACT

A multi-direction roller structure for an input device is provided. The multi-direction roller structure includes a roller, a switch actuator, a left push-on switch and a right push-on switch. The roller includes an axle stretching to both sides. The switch actuator includes a left supporting portion and a right supporting portion opposite to each other for supporting the axle. When the roller pushes to the left and to the right respectively, the switch actuator inclines to the lower left and to the lower right respectively. The left push-on switch and the right push-on switch are located under the switch actuator. The left push-on switch or the right push-on switch is forcedly pushed down to generate switch signals when the switch actuator inclines to the lower left or to the lower right in order, respectively.

### RELATED APPLICATIONS

The present application is based on, and claims priority from, Taiwan Application Serial Number 94123795, filed Jul. 13, 2005, the disclosure of which is hereby incorporated by reference herein in its entirety.

### BACKGROUND

1. Field of Invention

The present invention relates to a multi-direction roller structure for an input device. More particularly, the present invention relates to a multi-direction roller structure, wherein the roller is able to be pushed to the left and to the right, and the pushed roller contacts and presses two different push-on switches respectively, such that the two different push-on switches generates different switch signals respectively.

2. Description of Related Art

It is disclosed in U.S. Pat. No. 5,912,661 “Z-Encoder Mechanism a mouse” a mouse with a microswitch installed appropriately under the roller of the mouse. The roller of the input device can be pushed down by the user to contact and press the push button of a microswitch, causing the microswitch to generate a switch signal. However, for the mouse disclosed in U.S. Pat. No. 5,912,661, the roller can only be pushed down vertically. Therefore, only a microswitch can be provided.

For the forgoing reasons, there is a need for a multi-direction roller structure applied in an input device, wherein it is able to push the roller to the left and to the right, such that the roll is pushed to contact and further press the two different push-on switches. In a consequence, the two different push-on switches generates different switch signal, respectively.

### SUMMARY

The present invention is directed to a multi-direction roller structure utilized an input device. The roller can roll forward and backward, and can be pushed toward the left and toward the right. Therefore, input devices can utilize these operations of the roller of the present invention to generate relative signals.

It is therefore an aspect of the present invention to provide a multi-direction roller structure for an input device.

In accordance with the foregoing and other aspects of the present invention, a multi-direction roller structure for an input device is provided that includes: a roller, a switch actuator, a left push-on switch and a right push-on switch. The roller includes an axle stretching to both sides. The switch actuator includes a left supporting portion and a right supporting portion opposite to each other for supporting the axle, wherein the switch actuator inclines to the lower left and to the lower right when the roller is pushed to the left and to the right respectively. The left push-on switch and the right push-on switch are located under the switch actuator. The left push-on switch or the right push-on switch is forcedly pushed down when the switch actuator inclines to the lower left or to the lower right in order to generate switch signals, respectively.

In conclusion, the invention allows a roller structure to operate in multi-directions. It is obvious to facilitate the window scrolling operation.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a pictorial of the multi-direction roller structure according one embodiment of the present invention;

FIG. 2 is a decomposition chart of the multi-direction roller structure according one embodiment of the present invention;

FIG. 3 is a pictorial of the multi-direction roller structure according another embodiment of the present invention; and

FIG. 4 is a decomposition chart of the multi-direction roller structure according another embodiment of the present invention.

### DESCRIPTION OF THE PREFERRED EMBODIMENTS

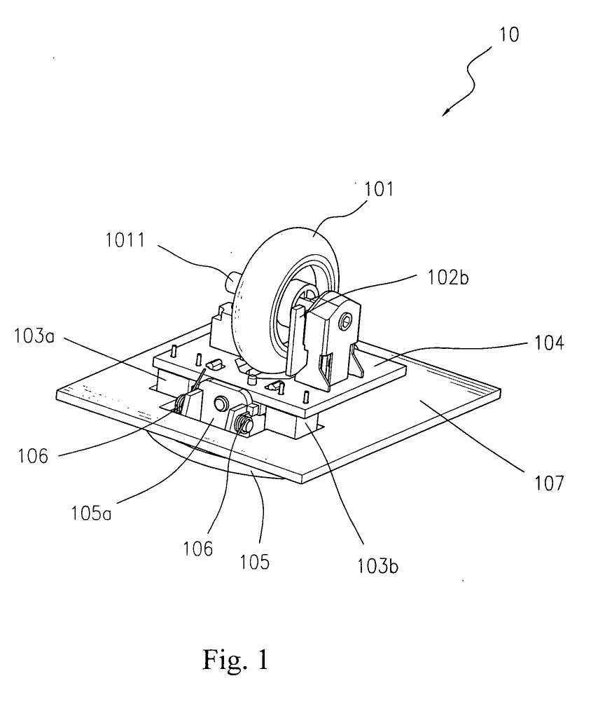

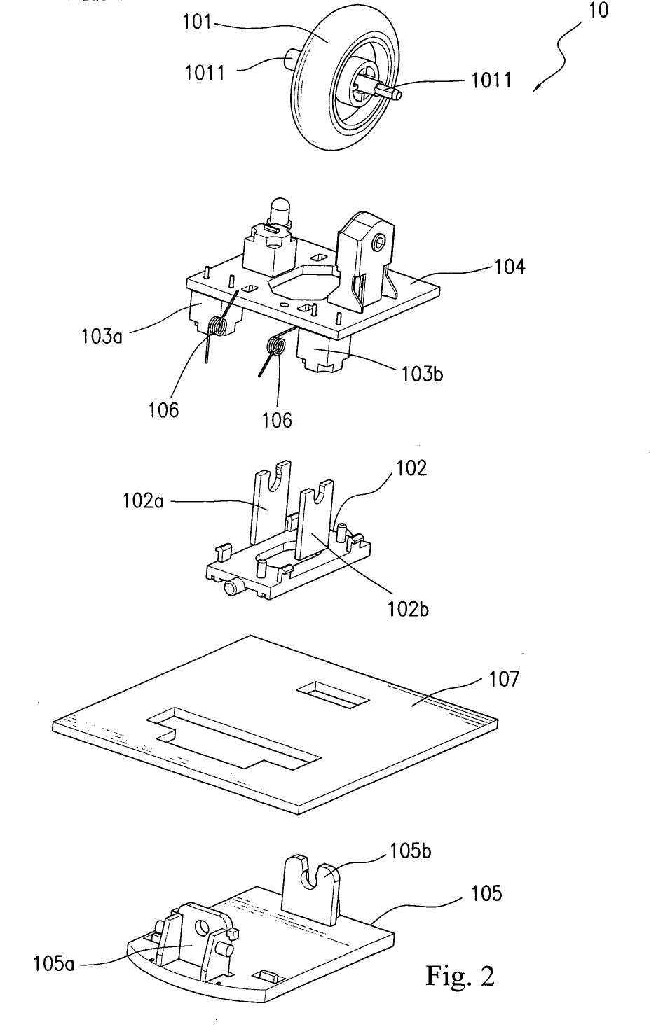

FIG. 1 is a pictorial of the multi-direction roller structure according one embodiment of the present invention, and FIG. 2 is a decomposition chart of the multi-direction roller structure according one embodiment of the present invention. The multi-direction roller structure 10 of the present invention is mainly applied in input devices. The specific embodiment of the input device may include a mouse, a track ball, a keyboard, or a presentation mouse. The roller 101 of the multi-direction roller structure 10 can not only roll forward and backward, but also can be pushed toward the left and toward the right. In accordance, the user can scroll the browse window in the direction of up, down, left and right by rolling the roller 101 forward and backward, and by pushing the roller 101 to the left and to the right. The multi-direction roller structure 10 of the present invention includes: a roller 101, a switch actuator 102, a left push-on switch 103a and a right push-on switch 103b, a rolling encoder assembly 104, a plate 105, and a flexible component 106. The roller 101 includes an axle 1011 near the center and stretching to both sides. The switch actuator 102 includes a left supporting portion 102a and a right supporting portion 102b opposite to each other. The plate 105 includes a front supporting portion 105a and a back supporting portion 105b opposite to each other. The left push-on switch 103a and the right push-on switch 103b are installed in the rolling encoder assembly 104.

The fabrication order of the multi-direction roller structure 10 of the present invention is illustrated below. Before fabrication, the rolling encoder assembly 104 is associated with the switch actuator 102 already. During the fabrication process, the front supporting portion 105a and the back supporting portion 105b pass through a front opening and a back opening of the intermediary board 107, and then fasten the switch actuator 102 that is associated with the rolling encoder assembly 104. The front supporting portion 105a and the back supporting portion 105b hereby support the switch actuator 102. Finally, the axle 1011 of the roller 101 is mounted on the left supporting portion 102a and the right supporting portion 102b. The flexible component 106 is utilized to recover the position of the switch actuator 102.

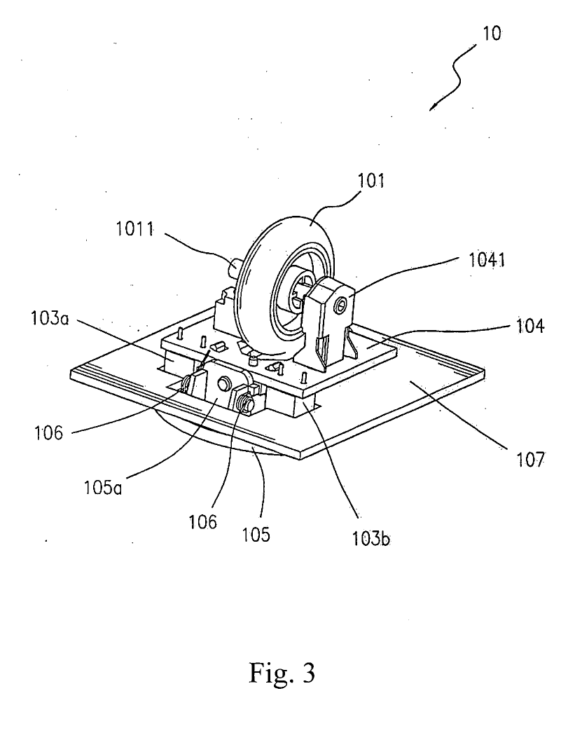

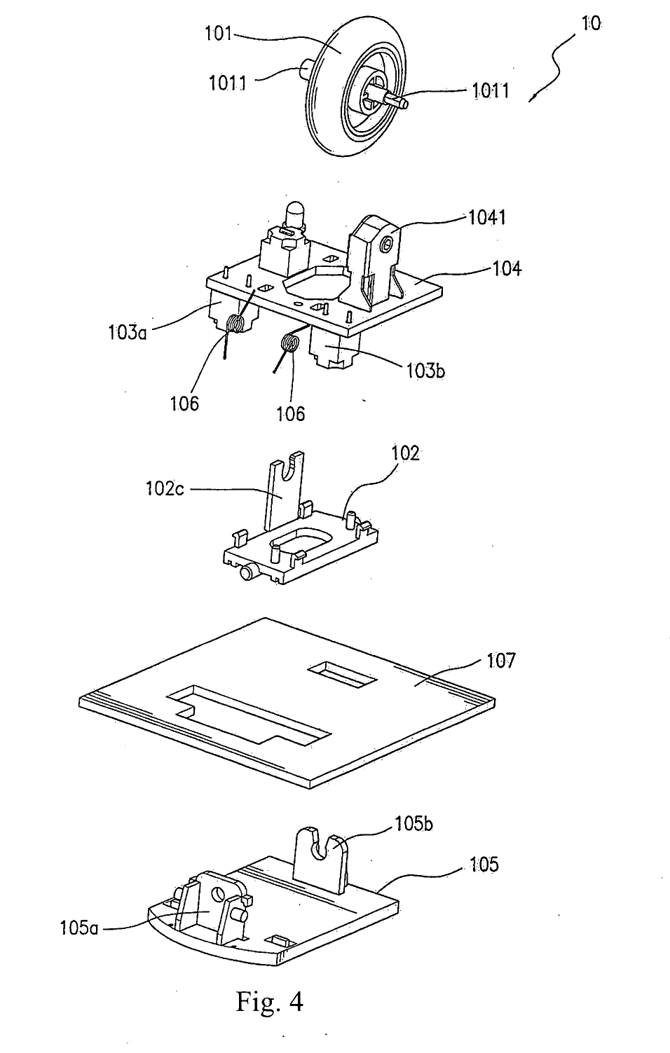

FIG. 3 is a pictorial of the multi-direction roller structure according another embodiment of the present invention, and FIG. 4 is a decomposition chart of the multi-direction roller structure according another embodiment of the present invention. The embodiment illustrated in FIGS. 3 & 4 is the same as the embodiment illustrated in FIGS. 1 & 2 except the design of the supporting portion. In this embodiment, the switch actuator 102 includes one supporting portion 102c to support an axle 1011, and the supporting portion 102c is installed opposite to a position where the rolling encoder 1041 is located. Two ends of the axle 1011 are pivotally connected with the supporting portion 102c and the rolling encoder 1041.

According to embodiments of the present invention, the rolling encoder assembly 104 generates corresponding encoding signal when the user rolls the roller 101 forward or backward. When the user pushes the roller 101 to the left or to right such that the roller 101 inclines to the lower left or to the lower right with an angle, respectively, the switch actuator 102 is pushed further and inclines to the lower left or to the lower right with an angle. When the switch actuator 102 inclines to the lower left or to the lower right with an angle, the switch actuator 102 forces either the left push-on switch 103a or the right push-on switch 103b to contact and press the plate 105. Hence either the left push-on switch 103a or the right push-on switch 103b generates the switch signal accordingly.

The multi-direction roller structure 10 of the present invention is applied in scrolling the scroll bar of the browsing windows upward, downward or toward the left or the right. The operation of rolling forward/backward and pushing to the left/right of the roller 101 obviously brings a great amount of convenience in scrolling the window. This advantage is unreachable for the conventional input devices.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A multi-direction roller structure for an input device, installed in an input device, the multi-direction roller structure comprising:
a roller, comprising an axle stretching to two sides;
a switch actuator, comprising a left supporting portion and a right supporting portion opposite to each other, wherein the left supporting portion and the right supporting portion are utilized to support the axle, and the switch actuator inclines to the lower left and to the lower right respectively when the roller pushes to the left and to the right; and
a left push-on switch and a right push-on switch, being forcedly pushed down respectively when the switch actuator inclines to the lower left and to the lower right.

2. The multi-direction roller structure of claim 1, wherein the left push-on switch and the right push-on switch are located under the switch actuator, respectively.

3. The multi-direction roller structure of claim 1, further comprising:
a rolling encoder assembly, for generating encoding signal when the roller rolls; and
a plate, comprising a front supporting portion and a back supporting portion opposite to each other, wherein the front supporting portion and the back supporting portion are for supporting the switch actuator.

4. The multi-direction roller structure of claim 3, wherein the rolling encoder assembly is associated with the switch actuator.

5. The multi-direction roller structure of claim 3, further comprising a flexible component for recover the position of the switch actuator.

6. The multi-direction roller structure of claim 1, wherein the input device is a mouse.

7. The multi-direction roller structure of claim 1, wherein the input device is a track ball.

8. The multi-direction roller structure of claim 1, wherein the input device is a presentation mouse.

9. The multi-direction roller structure of claim 1, wherein the input device is a keyboard.

10. A multi-direction roller structure for an input device, installed in an input device, the multi-direction roller structure comprising:
a roller, comprising an axle stretching to two sides;
a switch actuator, comprising at least one supporting portion to support the axle, wherein the switch actuator inclines to the lower left and to the lower right respectively when the roller pushes to the left and to the right respectively; and
a left push-on switch and a right push-on switch, being forcedly pushed down respectively when the switch actuator inclines to the lower left and to the lower right.

11. The multi-direction roller structure of claim 10, wherein the left push-on switch and the right push-on switch are located under the switch actuator, respectively.

12. The multi-direction roller structure of claim 10, wherein the switch actuator comprises one supporting portion to support the axle.

13. The multi-direction roller structure of claim 10, further comprising:
a rolling encoder assembly, for generating encoding signal when the roller rolls; and
a plate, comprising a front supporting portion and a back supporting portion opposite to each other, wherein the front supporting portion and the back supporting portion are for supporting the switch actuator.

14. The multi-direction roller structure of claim 13, wherein the rolling encoder assembly is associated with the switch actuator.

15. The multi-direction roller structure of claim 13, further comprising a flexible component for recover the position of the switch actuator.

16. The multi-direction roller structure of claim 10, wherein the input device is a mouse.

17. The multi-direction roller structure of claim 10, wherein the input device is a track ball.

18. The multi-direction roller structure of claim 10, wherein the input device is a presentation mouse.

19. The multi-direction roller structure of claim 10, wherein the input device is a keyboard.
